(19) United States
(12) Patent Application Publication
(10) Pub. No.: US 2015/0258946 A1
(43) Pub. Date: Sep. 17, 2015

(54) SPLIT-RAIL VEHICLE POWER ARCHITECTURE

(71) Applicant: GM GLOBAL TECHNOLOGY OPERATIONS LLC, Detroit, MI (US)

(72) Inventors: Chandra S. Namuduri, Troy, MI (US); Alan G. Holmes, Clarkston, MI (US); Michael G. Reynolds, Troy, MI (US); Thomas Wolfgang Nehl, Shelby Township, MI (US)

(73) Assignee: GM GLOBAL TECHNOLOGY OPERATIONS LLC, Detroit, MI (US)

(21) Appl. No.: 14/208,390

(22) Filed: Mar. 13, 2014

(51) Int. Cl. B60R 16/03

(52) U.S. Cl. CPC B60R 16/03

(57) ABSTRACT

A vehicle includes a chassis, engine, transmission, electric machine operable to selectively power the engine, and an electrical system. The electrical system includes a DC propulsion energy storage system (P-ESS) and a DC auxiliary ESS (A-ESS). Positive terminals of the two ESSs are electrically connected. The A-ESS negative terminal connects to the chassis as an electrical ground. The P-ESS negative terminal is not connected to ground, such that voltage levels of the P-ESS negative terminal float with respect to ground. A power invertor module (PIM) is connected to the MGU via an AC propulsion bus, and to the positive and negative terminals of the P-ESS. Positive input terminal and output terminals of a DC-DC converter system are tied together and connected to positive terminals of the P-ESS and A-ESS. A negative input terminal of the DC-DC converter system is electrically connected to the negative terminal of the P-ESS.

### TECHNICAL FIELD

The present disclosure relates to a split-rail vehicle power architecture.

### BACKGROUND

Hybrid electric powertrains are able to command an engine autostop at idle conditions to improve fuel economy. After an autostop event, a motor/generator unit (MGU) may be used to quickly restart the engine. Motor output torque from the MGU may also be used as needed in some hybrid powertrain configurations in addition to the output torque from the engine in what is referred to as an electrical assist mode. During regenerative braking or other regenerative events, negative torque from the MGU may be used to recharge a battery. The stored energy in the battery may be used instead of generating energy to support vehicle auxiliary loads during normal driving conditions, thereby reducing fuel consumption. Conventional vehicles may not use a belted starting system, but may instead use a starter motor to autostart the engine. The belt-driven generator is used strictly for high-power regeneration under specific operating conditions such as coasting or braking, or for steady power generation under normal operating conditions as needed.

Strong/full or mild hybrid powertrains are typically rated at about 30-360 VDC. Such voltage levels are considered to be high-voltage relative to 12 VDC auxiliary voltage levels. Therefore, a separate high-voltage battery is used for powering the MGU and related power electronic devices, while an auxiliary battery may be used to power auxiliary vehicle loads such as headlights, heating or air conditioning system blowers, windshield wiper motors, and the like.

While strong/full and mild hybrid powertrains may utilize DC voltage levels in excess of 30 VDC, smaller “micro” hybrid powertrains greatly reduce the required power rating of the electric drive such that electric current can be easily managed at a nominal voltage level, which is typically below 30 VDC. As a significant part of the cost of an electric drive system depends on the required size and power rating of the MGU and associated power electronics, micro-hybrid powertrains may be a viable alternative to conventional hybrid designs in certain markets.

### SUMMARY

A “split-rail” electric architecture for a hybrid electric or a conventional vehicle is disclosed herein. The disclosed design is intended to minimize system losses and reduce vehicle cost relative to conventional designs. As is known in the art, arc faults require special handling in any electrical system, but particularly so in systems having relatively high voltage levels, e.g., 18 VDC or more. The present approach, via the split-rail architecture which maintains individual rail voltage levels within a predetermined range of electrical ground, may reduce the need for arc fault detection and voltage isolation circuitry of the type used in strong/full and mild hybrid power architectures. These and other possible advantages will be readily apparent to one of ordinary skill in the art in light of the present disclosure.

In a possible configuration, the vehicle may include an internal combustion engine, a transmission, and an electrical system. The electrical system utilizes two different batteries or energy storage systems: a propulsion energy storage system (P-ESS), e.g., with a nominal voltage of 24-30 VDC, and a lower-voltage auxiliary ESS (A-ESS), for instance with a nominal voltage of 12-15 VDC, or about half of the voltage level of the P-ESS. The P-ESS and the A-ESS each have a respective positive and negative terminal. A controller may be included in the vehicle design to control the powertrain through engine start/stop, regeneration, and electrical assist modes, and to maintain the propulsion energy storage device terminal voltage magnitudes within nominal 12-18 VDC limits with respect to the vehicle chassis, i.e., electrical ground, which is referred to herein as the “chassis ground”.

In the split-rail power architecture disclosed herein, the positive terminal of the P-ESS is electrically connected to the positive terminal of the A-ESS, and the negative terminal of the A-ESS is electrically connected to the chassis ground. Rather than being connected to a common electrical ground with the negative terminal of the A-ESS, the voltage level of the negative terminal of the P-ESS is instead permitted to vary or “float” with respect the voltage level at the negative terminal of the A-ESS.

By not connecting the negative terminal of the P-ESS to a common ground, e.g., to the chassis ground, the negative terminal of the P-ESS is forced to remain at within a predetermined range of the voltage level of the chassis ground, such as within 12-18 VDC of the chassis ground. This splitting of the positive and negative rails of a DC propulsion bus with respect to the chassis ground thus allows the absolute voltages of the DC bus rails to remain within the limits of a nominal auxiliary system. The present design thereby eliminates many of the ground fault-related arcing issues typically associated with 24 VDC or higher voltage levels.

A vehicle in a particular embodiment includes a chassis, an engine, a transmission connected to the engine, a polyphase electric machine connected to a crankshaft of the engine and operable to selectively power the engine, and an electrical system. The electrical system includes a DC propulsion energy storage system (P-ESS) and a DC auxiliary energy storage system (A-ESS) each having a respective positive and a negative terminal. The positive terminals of the P-ESS and the A-ESS are electrically connected to each other. The negative terminal of the A-ESS is electrically connected to the chassis such that the chassis forms an electrical ground. The negative terminal of the P-ESS is not connected to the electrical ground, such that a voltage level of the negative terminal of the P-ESS is allowed to float or vary with respect to a voltage level of the electrical ground.

The voltage level of the P-ESS may be in the range of about 24-30 VDC, in which case the predetermined voltage range is in the range of about 12-15 VDC.

The vehicle may also include a power invertor module (PIM) and a controller. In some embodiments, the PIM, the DC-DC converter system, and the MGU may be integrated, i.e., the PIM and DC-DC may be packaged into a housing of the MGU so as to minimize cable runs and connectors. The PIM has an alternating current (AC) side that is electrically connected to the MGU via an AC propulsion bus, and a DC side that is electrically connected to the positive terminal and the negative terminal of the P-ESS. In case of a conventional vehicle, the electrical generator may have an integrated active or passive rectifier and field regulator circuit to control the output voltage and/or current at a given rotational speed of the generator.

The vehicle may also include a DC-DC converter system having a positive input terminal and a positive output terminal that are tied together and connected to the positive terminals of the P-ESS and the A-ESS. The DC-DC converter system may include a negative input terminal that is electrically connected to the negative terminal of the P-ESS. A negative output terminal of the DC-DC converter system in this embodiment may be electrically connected to a negative terminal of the A-ESS.

The DC-DC converter may include first and second semiconductor switches and a gate driver circuit. A controller selectively transmits pulse width modulation switching signals to the semiconductor switches to separately establish a buck mode and a boost mode of the DC-DC converter system.

The vehicle may include a first pulley connected to the crankshaft, a second pulley connected to the electric machine, and a belt connected between the first and second pulleys. Such an embodiment provides for a belted alternator starter (BAS) system. The vehicle may include a first ring gear on the flywheel of the crankshaft and second pinion gear on a shaft of an auxiliary starter motor in mechanical engagement with the first ring gear. In such an embodiment, geared starting of the engine is enabled in a conventional powertrain.

An electrical system is also disclosed for the vehicle noted above. In a possible configuration, the electrical system includes an AC propulsion bus, a DC propulsion energy storage system (P-ESS) having a positive terminal and a negative terminal, a DC propulsion bus, a power invertor module (PIM), e.g., for a hybrid vehicle, or a rectifier and voltage regulator module in a conventional vehicle, and a DC auxiliary energy storage system (A-ESS). The PIM or rectifier/regulator has an AC side that is electrically connected to the electric machine via the AC propulsion bus, and a DC side that is electrically connected to the positive terminal and the negative terminal of the P-ESS.

The A-ESS of this embodiment has positive and negative terminals. The positive terminals of the P-ESS and the A-ESS are electrically connected to each other, while the negative terminal of the A-ESS is electrically connected to the chassis to form an electrical ground. Additionally, the negative terminal of the P-ESS is not connected to the electrical ground, such that a voltage level of the negative terminal of the P-ESS is allowed to float or vary with respect to a voltage level of the electrical ground.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of an example vehicle having an electrical system with a split-rail power architecture as set forth herein.

FIG. 2 is a schematic circuit diagram of an example embodiment of a DC-DC converter system that is usable as part of the split-rail architecture shown in FIG. 1.

FIG. 3 is a table describing boost and buck modes of the DC-DC converter system shown in FIG. 2.

### DETAILED DESCRIPTION

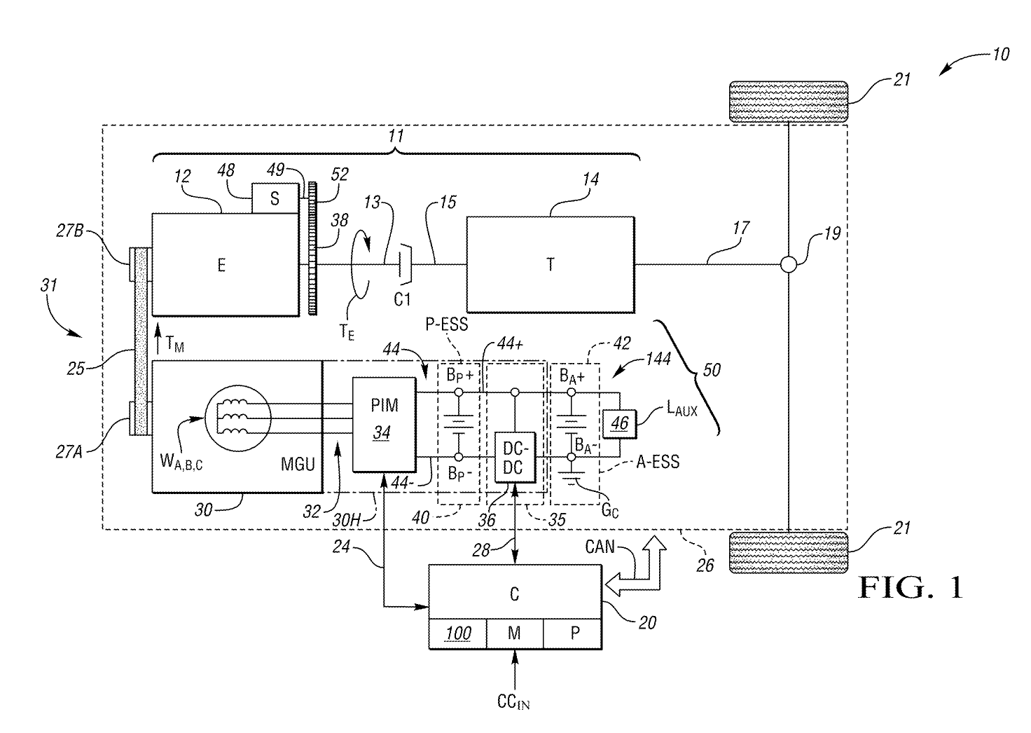

Referring to the drawings, wherein like reference numbers refer to like components throughout the several views, FIG. 1 depicts a schematic example vehicle 10 having a powertrain 11 and a chassis 26. The powertrain 11 includes an internal combustion engine (E) 12 with a crankshaft 13 that is selectively connected to an input member 15 of a transmission (T) 14, for instance via an input clutch C1. The transmission 14 may include a gearing arrangement and clutches (not shown) through which torque flows from the input member 15 to an output member 17 of the transmission 14, and ultimately through a final drive 19 to drive wheels 21 of the vehicle 10.

A polyphase electric machine in the form of an example motor/generator unit (MGU) 30 having a housing 30H is connected to the crankshaft 13 and operable for powering generation and for starting the engine 12. In a conventional vehicle, the MGU 30 will function as a generator only, and thus would be more accurately described as a generator unit. For illustrative consistency, the electric machine will be referred to hereinafter as MGU 30. In a possible embodiment, the MGU 30 may be embodied as an alternating current (AC) three-phase electric machine having three different phase windings (W_{A,B,C}), with each phase winding carrying a corresponding phase current for a respective A, B, and C phase, as is understood in the art. In various example embodiments, the MGU 30 may be constructed as a wound-field synchronous machine, a wound-field claw pole (Lundell) synchronous machine, a permanent magnet embedded claw pole (Lundell) machine, a permanent magnet synchronous machine, or a synchronous reluctance machine with or without permanent magnets within its rotor. The MGU 30 may also be an induction machine.

The MGU 30 of FIG. 1 may be operatively connected to the crankshaft 13 by a drive train 31 as shown. The drive train 31 may include a rotatable belt 25 that engages with first and second pulleys 27A and 27B, respectively. In such an embodiment, the first pulley 27A is connected to and rotatable via motor output torque (arrow T_{M}) from the MGU 30. The second pulley 27B is likewise connected to and rotatable via the crankshaft 13. Alternatively, the drive train 31 may include a chain in lieu of the belt 25, and sprockets in lieu of the respective first and second pulleys 27A and 27B, or any other suitable drive system. Construction and use of the MGU 30 in this manner is referred to as a belted alternator starter (BAS) system. The MGU 30 may also selectively deliver the motor output torque (T_{M}) to the crankshaft 13 when the engine 12 is running to selectively add to or assist engine output torque (T_{E}) from the engine 12 in what is referred to as an electric assist mode.

The engine 12 may also include a flywheel (not shown) that rotates in conjunction with the crankshaft 13. An auxiliary starter motor (S) 48 having a rotor shaft 49 is operatively connectable to the crankshaft 13, e.g., via a pinion gear 52. A ring gear 38 may be positioned on the crankshaft 13, for instance on a flywheel (not shown) of the engine 12, with the pinion gear 52 connected to and rotatable by the rotor shaft 49. The pinion gear 52 is in direct mechanical engagement with the ring gear 38, for instance via meshing of splines of the pinion gear 52 and the ring gear 38. In such an embodiment, geared starting of the engine 12, for instance in a conventional powertrain or a hybrid powertrain using the starter motot 48 as a backup or assisting source for cranking and starting the engine 12. A solenoid (not shown) may be selectively energized via a voltage from an auxiliary energy storage system (A-ESS) 42 to engage the starter motor 48 with the ring gear 38 whenever torque is needed from the starter motor 48 to crank and start the engine 12, for instance under cold ambient conditions or when the MGU 30 is not otherwise available for starting of the engine 12, such as is the case in a conventional/non-hybrid vehicle design.

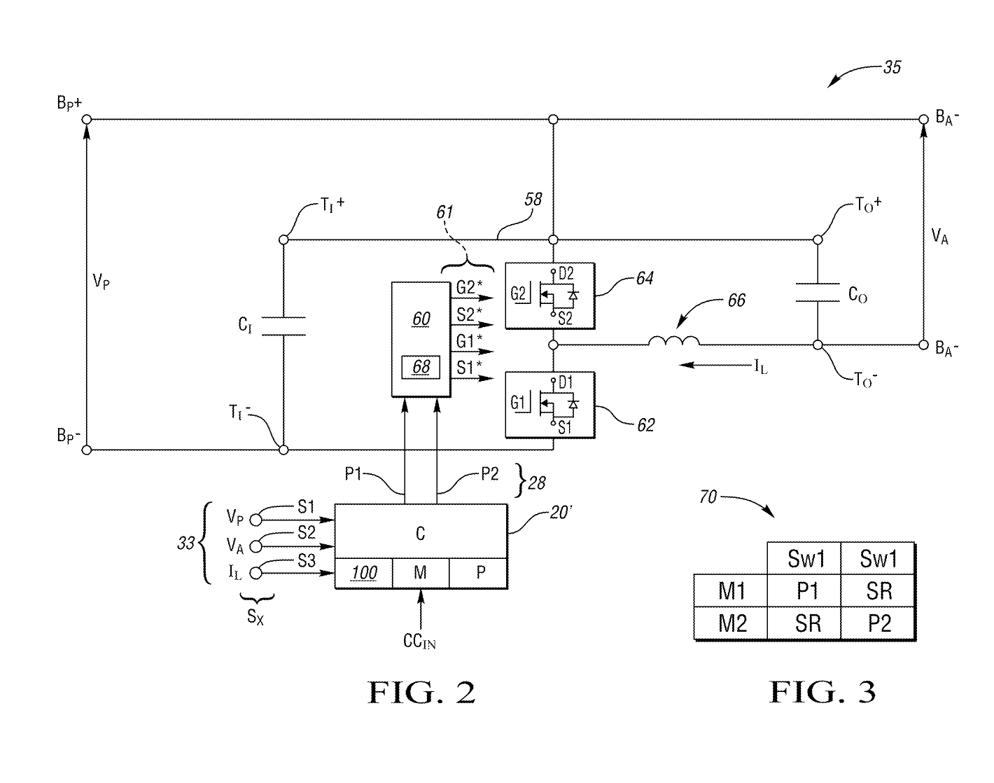

The powertrain 11 shown in FIG. 1 also includes an electrical system 50. The electrical system 50 may include a power inverter module (PIM) 34, a DC-DC converter system 35, an example embodiment of which is shown in FIG. 2, a propulsion energy storage system (P-ESS) 40, and the A-ESS 42. In some embodiments, the PIM 34 and the DC-DC converter system 35 may be packaged together within the housing 30H of the MGU 30, as indicated in phantom in FIG. 1. The electrical system 50 may also include an auxiliary vehicle load (L_{AUX}) 46, e.g., typical 12-15 VDC vehicle systems such as windshield wipers, headlights, entertainment system components, and the like.

The PIM 34 is electrically connected to the MGU 30 via a polyphase AC propulsion bus 32. As is known in the art, a power inverter module such as the PIM 34 includes various semiconductor switches (not shown) and circuit components which collectively operate to convert AC power to DC power and vice versa as needed, e.g., via pulse width modulation. This is achieved via PIM switching signals (arrow 24) from a controller (C) 20. Therefore, the polyphase output from the MGU 30 is converted, via the PIM 34, into DC power suitable for powering the auxiliary vehicle load 46 and charging the P-ESS 40 and the A-ESS 42 as needed.

The controller 20 of FIG. 1 is operable for controlling powerflow through the electrical system 50 as well as governing the overall operation of the powertrain 11. The controller 20 is in communication with the engine 12, the transmission 14, the MGU 30, and the electrical system 50, e.g., via a controller area network (CAN) bus, and may be configured as a single or distributed control device, e.g., as an engine control module, transmission control module, battery control module, etc. Although omitted from FIG. 1 for illustrative simplicity, connectivity between the controller 20 and the powertrain 11 may include any required transfer conductors, for instance a hard-wired or wireless control link(s) or path(s) suitable for transmitting and receiving the necessary electrical control signals for proper power flow control and coordination aboard the vehicle 10. The controller 20 may include such control modules and capabilities as might be necessary to execute all required power flow control functionality aboard the vehicle 10 in the desired manner.

The controller 20 shown in FIG. 1 may include a processor (P) and tangible, non-transitory memory (M), e.g., read only memory (ROM), whether optical, magnetic, flash, or otherwise. The controller 20 may also include sufficient amounts of random access memory (RAM), electrically-erasable programmable read only memory (EEPROM), and the like, as well as a high-speed clock, analog-to-digital (A/D) and digital-to-analog (D/A) circuitry, and input/output circuitry and devices (I/O), as well as appropriate signal conditioning and buffer circuitry. Logic 100 is recorded in memory (M), with the execution of the logic 100 by the processor (P) causing the controller 20 to manage the powerflow within the vehicle 10 as set forth below.

In addition to control of the PIM 34, the controller 20 is configured to control operation of any hardware components 36 of the DC-DC converter system 35 via DC-DC converter control signals (arrow 28). Example hardware components 36 are depicted in FIG. 2 and described below. Control of the electrical system 50 and the powertrain 11 is achieved in response to receipt by the controller 20 of a set of input signals (CC_{IN}), for instance throttle and braking levels, vehicle speed, transmission input and/or output speed, speeds and/or temperatures of the MGU 30 and engine 12, and the like.

In the “split-rail” power architecture shown in FIG. 1, the positive terminal (B_{P}⁺)) of the P-ESS 40 is electrically connected directly to the positive terminal (B_{A}⁺) of the A-ESS 42, i.e., with no intervening components other than the electrical conductors and any protection devices such as fuses (not shown) forming the connection. The negative terminal (B_{A}⁻) of the A-ESS 42 is electrically connected to the chassis 26, which thus acts as an electrical ground. In this capacity, the chassis 26 is referred to herein as the chassis ground (G_{C}). The negative terminal (B_{P}⁻) of the P-ESS 40 is not connected to the chassis ground (G_{C}) or to other electrical ground serving as a common ground with the negative terminal (B_{A}⁻) of the A-ESS 42. Therefore, the voltage level of the negative terminal (B_{P}⁻) of the P-ESS 40 is permitted to vary or “float” with respect the voltage level of the negative terminal (B_{A}⁻) of the A-ESS 42 or chassis ground (G_{C}).

The PIM 34 is supplied by respective positive and negative rails 44⁺, 44⁻ of the DC propulsion bus 44, e.g., at ±12 VDC potential with respect to the chassis ground (G_{C}). The negative terminal (B_{P}⁻) of the P-ESS 40 remains within a predetermined range of the voltage level of the chassis ground (G_{C}), e.g., at approximately −12 to −15 VDC with respect to the chassis ground (G_{C}) in a 12-15 VDC auxiliary voltage embodiment. An auxiliary DC bus 144 is also part of the architecture of FIG. 1. Splitting of the respective positive and negative rails 44⁺ and 44⁻ of the DC propulsion bus 44 with respect to the chassis ground (G_{C}) allows the absolute voltages of the positive and negative rails 44⁺, 44⁻ to likewise remain within nominal 12-15 VDC auxiliary limits with respect to the voltage level of the chassis ground (G_{C}). The design disclosed herein is thus intended to help eliminate ground fault-related arcing issues of the type typically associated with voltage levels at or above 18 VDC.

An example embodiment of the DC-DC converter system 35 of FIG. 1 is shown in FIG. 2. FIG. 2 depicts an area of the electrical system 50 shown in FIG. 1 spanning between the respective positive and negative input terminals B_{P}⁺ and B_{P}⁻ of the P-ESS 40 of FIG. 1 and the respective positive and negative terminals B_{A}⁺ and B_{A}⁻ of the A-ESS 42. Components of this embodiment may include an input capacitor (C_{I}) that is connected in parallel with the positive and negative input terminals (T_{I}⁺, T_{I}⁻) of the DC-DC converter system 35, a first switch (Sw1) 62, a second switch (Sw2) 64, and an output capacitor (Co) connected across the positive and negative output terminals (T_{O}+, T_{O}−) of the A-ESS 42 of FIG. 1.

The DC-DC converter system 35 has a positive terminal T₁⁺ of the input capacitor C_{I} and a positive terminal T_{O}+ of the output capacitor C_{O} that are electrically tied together as shown via a conductor 58, and electrically connected to the respective positive terminals B_{P}⁺ and B_{A}⁺ of the P-ESS 40 and the A-ESS 42. The DC-DC converter system 35 also has a negative input terminal T_{I}⁻ that is electrically connected to the negative terminal B_{P}⁻ of the P-ESS 40 and a negative output terminal T_{O}− that is electrically connected to the negative terminal B_{A}− of the A-ESS 42 which is also connected to the chassis ground (G_{C}), not shown in FIG. 2.

The respective first and second switches 62, 64 may be embodied as semiconductor switches, for instance as metal-oxide semiconductor field effect transistors (MOSFETs) as shown. The terminals of a typical MOSFET include a gate (G1 or G2), a source (S1 or S2), and a drain (D1 or D2). A propulsion voltage (V_{P}) equal to the voltage level or potential of the P-ESS 40 of FIG. 1 is present across the positive and negative terminals (B_{P}⁺, B_{P}⁻) of the P-ESS 40. An auxiliary voltage (V_{A}) is likewise present across the positive and negative terminals (B_{A}⁺, B_{A}⁻) of the A-ESS 42. An electrical current (arrow I_{L}) flows across an inductor 64 as shown in this example configuration.

The controller 20, specifically any portion of the controller 20 dedicated to the control of the DC-DC converter system 35, may be powered by the auxiliary voltage (V_{A}) from the A-ESS 42 of FIG. 1. The propulsion voltage (V_{P}) may be sensed differentially, e.g., using a first sensor S1 of a sensor set S_{X}, with the first sensor S1 being a differential amplifier in a possible design. The auxiliary voltage (V_{A}) may be likewise sensed via a second sensor S2, for instance another differential amplifier or other suitable sensor, while a third sensor S3 may be used to measure the current (I_{L}) flowing through the inductor 64. The collected electrical inputs 33 describe the values V_{P}, V_{A}, and I_{L}.

Output signals 61 from the gate driver circuit 60, which may be an integrated circuit or chipset, include a first and second gate biasing signal (G1*, G2*) and a first and second source signal (S1*, S2*), respectively. The gate driver biasing signals (G1*, G2*) may be derived by the controller 20 from the propulsion voltage (V_{P}) and level-shifted by the controller 20 as needed to drive the respective first and second switches Sw1 and Sw2.

That is, the controller 20 is configured to selectively activate, i.e., turn on or off, the first and switches Sw1 and Sw2 as needed, such as via delivery of a voltage pulse to a selected one of the gates G1 or G2. Thus, electrical current flowing through the electrical system 50 of FIG. 1 is controlled via the selected state of the first and second switches Sw1 and Sw2. Control signals transmitted by the controller 20 to the first and second switches Sw1 and Sw2 may be level-shifted with respect to the chassis ground (G_{C}) using any suitable electronic device 68, for instance optocouplers, pulse transformers, dielectric isolators, etc. Switching signals (arrows P1 and P2) are transmitted to the gate driver circuit 60 to cause the required state changes in the switches Sw1 and Sw2.

Referring to FIG. 3, a table 70 depicts two possible modes of operation of the DC-DC converter system 35 of FIG. 2: a buck mode (M1) and a boost mode (M2). As understood by those having ordinary skill in the art, a buck-boost converter is a DC-DC converter having an output voltage magnitude that exceeds or is less than the input voltage in magnitude, whichever is needed for a given state or operating mode. In other words, in the example of FIG. 2, the propulsion voltage V_{P} and the auxiliary voltage V_{A} may differ from each other, and ordinarily do. In buck mode, the voltage across the DC-DC converter system 35 decreases, while the opposite occurs in boost mode.

Buck mode operation is used for delivering power from the propulsion DC bus 44 to the auxiliary DC bus 144, and boost mode operation is used for charging the P-ESS 40 from the A-ESS 42 in case the state of charge of the P-ESS 40 is insufficient for functioning of the vehicle 10. Operation of the DC-DC converter system 35 in some embodiments may be selectively disabled whenever the MGU 30 operates in motoring mode, during a restart of the engine 12 via the MGU 30, and/or during torque assist of the engine 12 so as to maximize the power delivered to the engine 12 from the P-ESS 40.

Using the example design of FIG. 2, for the buck mode (M1), the voltage input to the first switch 62 may be controlled via pulse width modulation (PWM) signals (arrow P1) from the controller 20. When the first switch 62 is turned off, the second switch 64 is operated as a synchronous rectifier (SR). Likewise, when in boost mode (M2) the second switch 64 is controlled via a different set of PWM signals (arrow P2) from the controller 20. When the second switch 64 is off in boost mode, the first switch 62 is operated as a synchronous rectifier (SR). PWM signals P1 and P2 are thus part of the DC-DC converter control signals (arrow 28) shown schematically in FIG. 2. The term “synchronous rectifier” as used herein refers to any type of electronic switch that improves power-conversion efficiency by placing a low-resistance conduction path across the diode rectifier in a switch-mode regulator. Semiconductor switch designs capable of doing this may be used within the scope of the present invention, with the MOSFET design of FIG. 2 being merely illustrative.

The powertrain 11 described hereinabove, with the electrical system 50 as shown in FIGS. 1 and 2 as controlled per the table 70 of FIG. 3, is intended to provide a lower cost design that seeks to avoid arc fault-related issues, e.g., of conventional 18-30 VDC or higher voltage hybrid designs. The elimination of high-voltage isolation circuitry as well as reduced electronic packaging size enabled by the lower currents in the PIM, any DC cables, and the smaller MGU 30 of FIG. 1 may likewise provide certain design advantages.

While the best modes for carrying out the invention have been described in detail, those familiar with the art to which this invention relates will recognize various alternate designs and embodiments for practicing the invention within the scope of the appended claims.

1. A vehicle comprising:
a chassis;
an internal combustion engine having a crankshaft;
a transmission having an input member that is connected to the crankshaft;
a polyphase electric machine that is connected to the crankshaft, and that is operable for at least one of: selectively starting the engine, selectively assisting an output torque of the engine, and generating electrical power; and
an electrical system having a direct current (DC) propulsion energy storage system (P-ESS) and a DC auxiliary energy storage system (A-ESS) each having a respective positive and negative terminal;
wherein the positive terminal of the P-ESS and the positive terminal of the A-ESS are electrically connected to each other, the negative terminal of the A-ESS is electrically connected to the chassis such that the chassis forms an electrical ground, and the negative terminal of the P-ESS is not connected to the electrical ground, such that a voltage level of the negative terminal of the P-ESS is allowed to float or vary within a predetermined voltage range of the electrical ground.

2. The vehicle of claim 1, wherein the voltage level of the P-ESS is in a range of about 18-30 VDC, and the predetermined voltage range of the negative terminal of the P-ESS is within a range of about 12-15 VDC of the electrical ground.

3. The vehicle of claim 1, wherein the polyphase electric machine is a motor/generator unit (MGU), the vehicle further comprising a power inverter module (PIM) and a controller, wherein the PIM has an alternating current (AC) side that is electrically connected to the MGU via an AC propulsion bus, and a DC side that is electrically connected to the positive terminal and the negative terminal of the P-ESS.

4. The vehicle of claim 1, further comprising a DC-DC converter system having a positive input terminal and a positive output terminal that are electrically connected together and to the respective positive terminals of the P-ESS and the A-ESS, and a negative input terminal that is electrically connected to the negative terminal of the P-ESS.

5. The vehicle of claim 4, wherein the polyphase electric machine is a motor/generator unit (MGU), the vehicle further comprising a controller in communication with the DC-DC converter system, wherein the controller is programmed to temporarily disable the DC-DC converter system during a predetermined condition selected from the group consisting of: a motoring mode of the MGU, a restart of the engine via the MGU, and a torque assist of the engine via the MGU, to thereby maximize power delivered to the engine from the P-ESS.

6. The vehicle of claim 4, wherein a negative output terminal of the DC-DC converter system is electrically connected to a negative terminal of the A-ESS.

7. The vehicle of claim 4, wherein the vehicle includes a controller and the DC-DC converter includes a first and second semiconductor switch and a gate driver circuit, and wherein the controller is configured to selectively transmit pulse width modulation switching signals to the first and second semiconductor switches to separately establish a buck mode and a boost mode of the DC-DC converter system.

8. The vehicle of claim 4, wherein the polyphase electric machine includes a housing, and wherein the PIM and the DC-DC converter system are packaged together in the housing of the MGU.

9. The vehicle of claim 1, wherein the polyphase electric machine is a motor/generator unit (MGU), the vehicle further comprising a first pulley connected to the crankshaft, a second pulley connected to the MGU, and a belt connected between the first and second pulleys.

10. The vehicle of claim 1, wherein the polyphase electric machine is a generator and not a motor, the vehicle further comprising an auxiliary starter motor having a rotor shaft, a ring gear connected to the crankshaft, and a pinion gear positioned on the rotor shaft that is in mechanical engagement with the ring gear, and wherein the auxiliary starter motor is configured to selectively rotate the pinion gear to start the engine.

11. An electrical system for a vehicle having a chassis, an internal combustion engine having a crankshaft, a transmission having an input member that is connected to the crankshaft, and a polyphase electric machine connected to the crankshaft, the electrical system comprising:
an alternating current (AC) propulsion bus;
a direct current (DC) propulsion energy storage system (P-ESS) having a positive terminal and a negative terminal;
a direct current (DC) propulsion bus;
a power invertor module (PIM) that has an AC side that is electrically connected to the electric machine via the AC propulsion bus, and a DC side that is electrically connected to the positive terminal and the negative terminal of the P-ESS; and
a DC auxiliary energy storage system (A-ESS) having a positive and a negative terminal;
wherein the positive terminals of the P-ESS and the A-ESS are electrically connected to each other, the negative terminal of the A-ESS is electrically connected to the chassis to form an electrical ground, and the negative terminal of the P-ESS is not connected to the electrical ground, such that a voltage level of the negative terminal of the P-ESS is allowed to float or vary with respect to a voltage level of the electrical ground.

12. The electrical system of claim 11, further comprising a DC-DC converter system having a positive input terminal and a positive output terminal that are tied together and connected to the positive terminals of the P-ESS and the A-ESS, and a negative input terminal that is electrically connected to the negative terminal of the P-ESS.

13. The electrical system of claim 11, wherein a negative output terminal of the DC-DC converter system is electrically connected to a negative terminal of the A-ESS.

14. The electrical system of claim 11, wherein the voltage level of the P-ESS is in a range of about 18-30 VDC, and the predetermined voltage range of the negative terminal of the P-ESS is in a range of about 12-15 VDC of the electrical ground.

15. The electrical system of claim 11, wherein the DC-DC converter system includes a gate driver circuit and first and second semiconductor switches, and wherein the first and second semiconductor switch are activated via switching signals and the gate driver circuit to separately establish a buck mode and a boost mode of the DC-DC converter system.

16. The electrical system of claim 15, wherein the first and second semiconductor switches are metal-oxide semiconductor field effect transistors each having a gate, and wherein the gate driver circuit transmits gate biasing signals in response to the switching signals.

17. A vehicle comprising:
a chassis;
an alternating current (AC) propulsion bus;
a direct current (DC) propulsion bus;
an internal combustion engine having a crankshaft;
a transmission having an input member that is connected to the crankshaft;
a drive train having a first pulley connected to the crankshaft, a second pulley, and a belt connected between the first and second pulleys;
an alternating current (AC) motor generator unit (MGU) that is connected to the crankshaft via the drive train, and operable to selectively power the engine; and
an electrical system having a propulsion energy storage system (P-ESS) nominally rated for between 24-30 VDC, an auxiliary energy storage system (A-ESS) nominally rated for between 12-15 VDC, a power invertor module (PIM) with an alternating current (AC) side that is electrically connected to the MGU via the AC propulsion bus, and a DC side that is electrically connected to the positive terminal and the negative terminal of the P-ESS via the DC propulsion bus, and a DC-DC converter system;
wherein the positive terminals of the P-ESS and the A-ESS are electrically connected to each other, the negative terminal of the A-ESS is electrically connected to the chassis such that the chassis forms an electrical ground, and the negative terminal of the P-ESS is not connected to the electrical ground, such that a voltage level of the negative terminal of the P-ESS is allowed to float or vary with respect to a voltage level of the electrical ground; and
the DC-DC converter system includes a positive input terminal and a positive output terminal that are tied together and connected to the positive terminals of the P-ESS and the A-ESS, and also having a negative input terminal that is electrically connected to the negative terminal of the P-ESS.

18. The vehicle of claim 17, wherein a negative output terminal of the DC-DC converter system is electrically connected to a negative terminal of the A-ESS.

19. The vehicle of claim 17, wherein the vehicle includes a controller and the DC-DC converter includes a first and second semiconductor switch and a gate driver circuit, and wherein the controller is configured to selectively transmit pulse width modulation switching signals to the first and second semiconductor switches to separately establish a buck mode and a boost mode of the DC-DC converter system.

20. The vehicle of claim 17, wherein the MGU includes a housing, and the PIM and the DC-DC converter system are packaged together in the housing of the MGU.
